(19) United States
(12) Patent Application Publication
(10) Pub. No.: US 2026/0099376 A1
(43) Pub. Date: Apr. 9, 2026

(54) DYNAMIC DISTRIBUTED SPLIT PERCEPTION

(71) Applicant: QUALCOMM Incorporated, San Diego, CA (US)

(72) Inventors: Hussein METWALY SAAD, Poway, CA (US); Simone MERLIN, San Diego, CA (US); Peerapol TINNAKORNSRISUPHAP, San Diego, CA (US); Andres Oscar ALTIERI, Bures-sur-Yvette (FR); Abhijeet BISAIN, San Diego, CA (US); Anirudh RADHAKRISHNAN, San Diego, CA (US); Yann LEBRUN, Velizy-Villacoublay (FR); Belal Salama Amin KORANY, San Diego, CA (US); Jayeeta JAGANNATH, San Diego, CA (US)

(21) Appl. No.: 18/908,621

(22) Filed: Oct. 7, 2024

(51) Int. Cl. G06F 9/50

(52) U.S. Cl. CPC G06F 9/505; G06F 9/5033; G06F 9/5055; G06F 2209/509

(57) ABSTRACT

Various aspects of the present disclosure generally relate to wireless communication. In some aspects, a user equipment (UE) may receive one or more parameters associated with computing perception data for an extended reality (XR) application. The UE may transmit computing information indicating whether an external device is to perform one or more tasks associated with computing the perception data, wherein a determination of whether the external device is to perform the one or more tasks is based at least in part on the one or more parameters. Numerous other aspects are described.

### FIELD OF THE DISCLOSURE

Aspects of the present disclosure generally relate to wireless communication and specifically relate to techniques, apparatuses, and methods associated with dynamic distributed split perception.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving one or more parameters associated with computing perception data for an extended reality (XR) application. The method may include transmitting computing information indicating whether an external device is to perform one or more tasks associated with computing the perception data, wherein a determination of whether the external device is to perform the one or more tasks is based at least in part on the one or more parameters.

Some aspects described herein relate to a non-transitory computer-readable medium that stores a set of instructions for wireless communication by a UE. The set of instructions, when executed by one or more processors of the UE, may cause the UE to receive one or more parameters associated with computing perception data for an XR application. The set of instructions, when executed by one or more processors of the UE, may cause the UE to transmit computing information indicating whether an external device is to perform one or more tasks associated with computing the perception data, wherein a determination of whether the external device is to perform the one or more tasks is based at least in part on the one or more parameters.

Some aspects described herein relate to a UE for wireless communication. The UE may include one or more memories and one or more processors coupled to the one or more memories. The one or more processors may be configured to receive one or more parameters associated with computing perception data for an XR application. The one or more processors may be configured to transmit computing information indicating whether an external device is to perform one or more tasks associated with computing the perception data, wherein a determination of whether the external device is to perform the one or more tasks is based at least in part on the one or more parameters.

Some aspects described herein relate to an apparatus for wireless communication. The apparatus may include means for receiving one or more parameters associated with computing perception data for an XR application. The apparatus may include means for transmitting computing information indicating whether an external device is to perform one or more tasks associated with computing the perception data, wherein a determination of whether the external device is to perform the one or more tasks is based at least in part on the one or more parameters.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of devices designed for extended reality (XR) traffic applications, in accordance with the present disclosure.

FIGS. 4A-4D are diagrams of examples of distributed XR compute, in accordance with the present disclosure.

FIG. 5 is a diagram of an example of dynamic distributed split perception, in accordance with the present disclosure.

FIG. 6 is a diagram of an example associated with an offloading/split decision framework, in accordance with the present disclosure.

FIG. 7 is a diagram illustrating an example process performed, for example, at a UE or an apparatus of a UE, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, an application service may be a multi-modal service. The multi-modal service may be associated with multi-modal traffic. As used herein, “multi-modal traffic” may refer to traffic that is associated with multiple modes of an application. For example, some applications may generate multiple types of uplink flows of data (for example, multiple modes). As another example, an application (for example, an extended reality (XR) application or a virtual reality (VR) application) may generate audio data, video data, positioning data, haptic data, and/or other types of data that are each associated with the application. In some cases, to obtain the multi-modal traffic, the application may enable input from multiple sources, such as traffic flows for audio, video, positioning, and/or haptic, among other examples.

In some cases, the multi-modal data may comprise perception data. The perception data may include data that a device (e.g., a user equipment (UE), an XR device, or a device that is associated with multi-modal traffic, a multi-modal service, and/or a multi-modal application, among other examples) can utilize to build a perception or awareness of an environment surrounding the multi-modal device.

For example, the device may contain one or more sensors (e.g., an inertial measurement unit (IMU), a camera, a temperature sensor, a microphone, and/or another type of sensor) that obtain data that can be used to perform a perception technology. For example, the device may obtain data that can be used to perform spatial mapping, object recognition, hand tracking, and/or blockage detection (e.g., utilizing image data to detect whether a communication link or channel will be blocked by an object). As another example, the device may obtain data that can be used to generate a depth map, a three-dimensional (3D) reconstruction of the environment, a radio frequency (RF) map, an estimation of a position of a user, and/or an estimation of an orientation of the user.

In some cases, the device may utilize one or more perception algorithms to perform a perception technology. For example, the device may utilize a perception algorithm to render XR data (e.g., rendering XR video, rendering XR audio) and/or to process perception data captured by one or more sensors of the device to determine an environment of a user as the user moves from one location to another (e.g., using spatial mapping, 3D reconstruction, and/or object recognition technology). As another example, the device may utilize a perception algorithm to process the perception data to determine an action being performed by a user (e.g., using head motion, hand tracking, and/or eye tracking technology).

Additionally and/or alternatively, computations using a perception algorithm may be performed at an external device (e.g., an application server) and a result of performing the computations (e.g., rendered XR data) may be subsequently provided to the device (either directly or indirectly). This may conserve processing and/or battery resources of the device, enable XR devices to have smaller form factors, and/or may improve user experience due to the external device utilizing newer and/or more complex perception algorithms.

However, the benefits of offloading resource-intensive computations to an external device are not guaranteed and may depend on various factors such as the tasks being offloaded, radio conditions on a wireless communication link via which the data is communicated between the device and the external device, and/or application quality of experience (QoE) requirements. Further, in some cases, offloading resource-intensive computations may violate one or more privacy requirements of a user of the device. For example, a perception algorithm may operate on inputs that may contain sensitive user information such as a current location of the user, images of a user's home, images of a family member, or the like.

Various aspects relate generally to a dynamic distributed split perception architecture that dynamically decides which perception tasks to be offloaded and to which the device the perception tasks are to be offloaded based at least in part on various factors such as the tasks being offloaded, radio conditions on a wireless communication link via which the data is communicated between the device and the external device, application QoE requirements, and/or privacy requirements of a user. Some aspects more specifically relate to determining which perception tasks to be offloaded and to which the device the perception tasks are to be offloaded inside an XR stack of a device rather than within an XR application. In some aspects, the determination is made with respect to multiple tasks that are considered jointly.

In some aspects, the determination is made on a per task basis and for multiple portions, blocks, and/or sub-tasks of each task. In some aspects, the task may be offloaded to multiple external devices. In some aspects, the dynamic distributed split perception architecture may make the determinations based at least in part on privacy requirements of a user, a tasks dependency graph, an availability of an external device, a capability of an external device, and/or an application requirement for the task.

Particular aspects of the subject matter described in this disclosure can be implemented to realize one or more of the following potential advantages. In some examples, the described techniques can be used to enable the location at which an XR computation is to be performed for an XR device to be dynamically changed based at least in part on various conditions that may impact the rendering quality, the latency, the power consumption of the XR device, and/or the data rate of the transfer of the XR data. Accordingly, the techniques described herein may provide increased rendering quality for an application client of an XR device, may provide improved user experience for the XR device, may increase or prolong the battery life of the XR device, and/or may ensure that privacy requirements of the user are not violated, among other examples.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

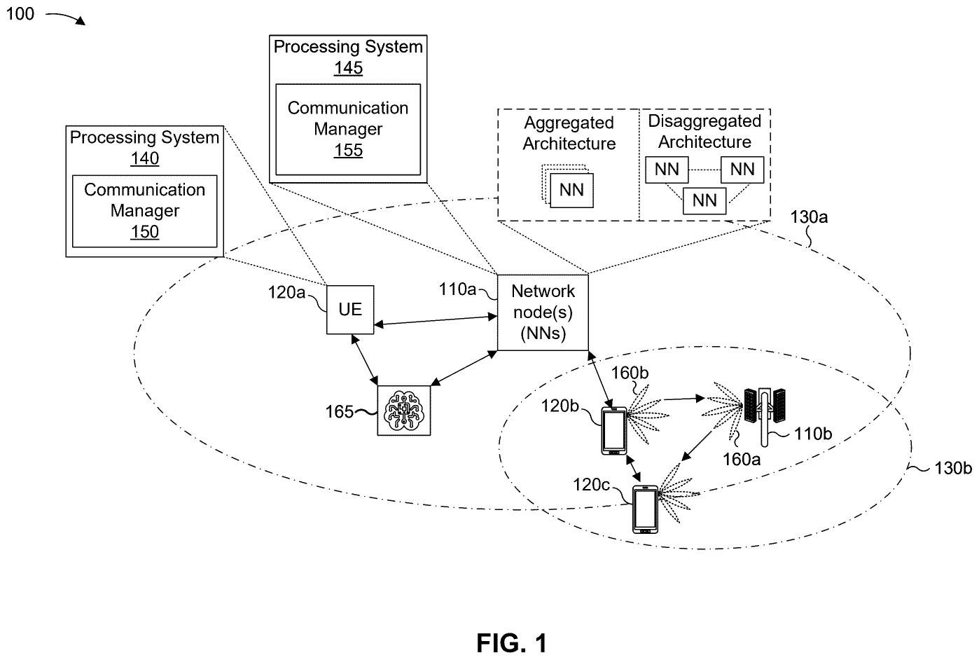

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

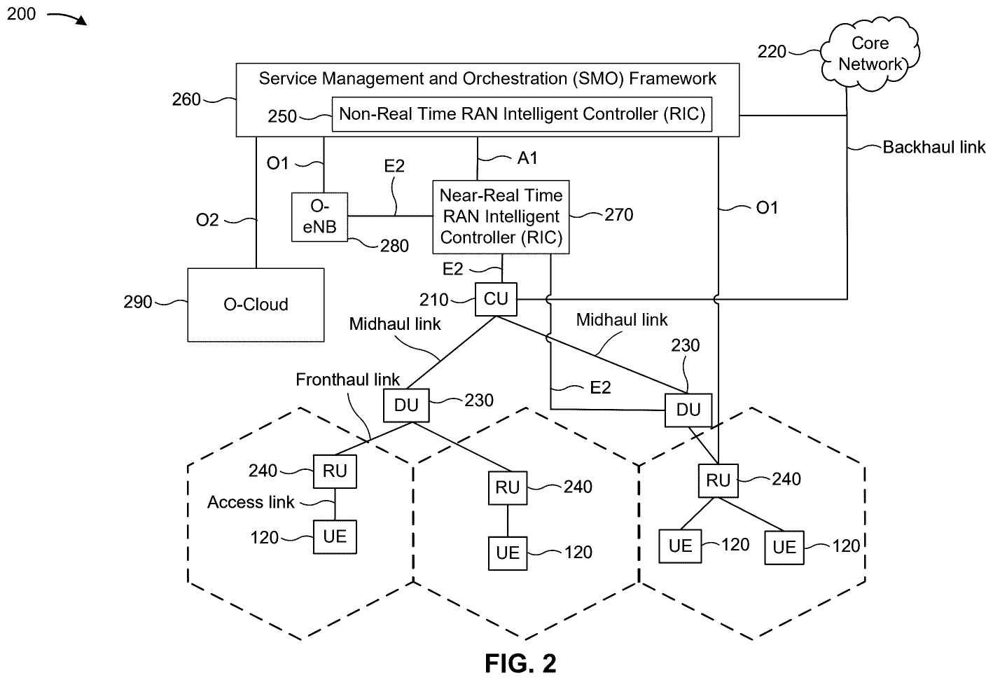

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE 120 may include a communication manager 150. As described in more detail elsewhere herein, the communication manager 150 may receive one or more parameters associated with computing perception data for an XR application; and transmit computing information indicating whether an external device is to perform one or more tasks associated with computing the perception data, wherein a determination of whether the external device is to perform the one or more tasks is based at least in part on the one or more parameters. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers.

Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

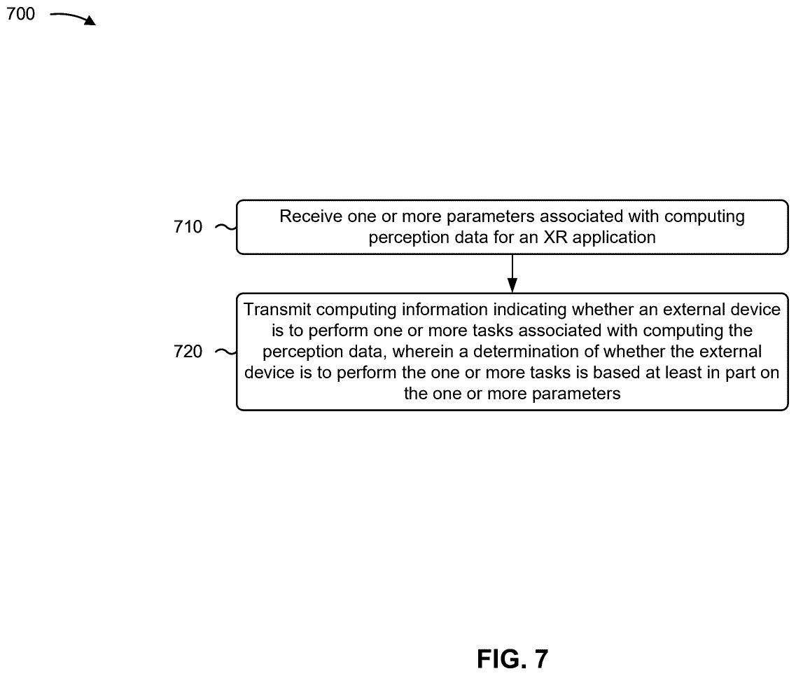

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with dynamic distributed split perception, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, or other processes as described herein (alone or in conjunction with one or more other processors). In some aspects, the XR device described herein is the UE 120, is included in the UE 120, or includes one or more components of the UE 120 shown in FIG. 1. Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, or other processes as described herein. In some examples, executing instructions may include running the instructions, converting the instructions, compiling the instructions, and/or interpreting the instructions, among other examples.

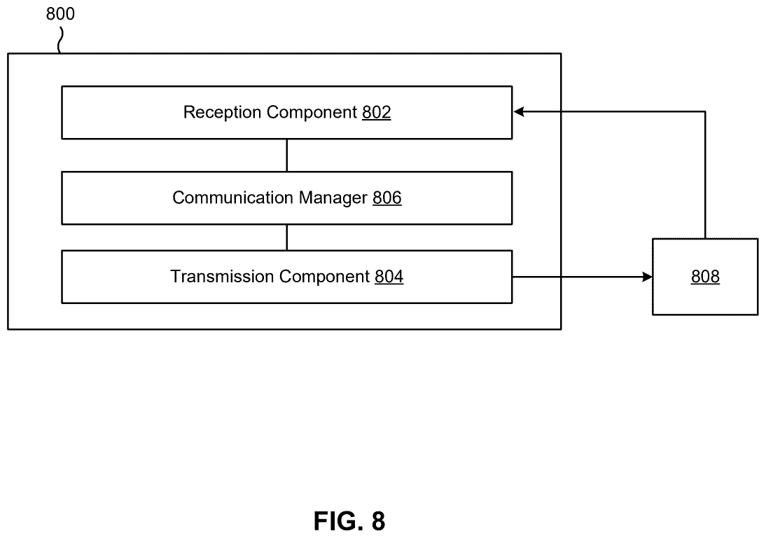

In some aspects, a UE includes means for receiving one or more parameters associated with computing perception data for an XR application; and/or means for transmitting computing information indicating whether an external device is to perform one or more tasks associated with computing the perception data, wherein a determination of whether the external device is to perform the one or more tasks is based at least in part on the one or more parameters. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

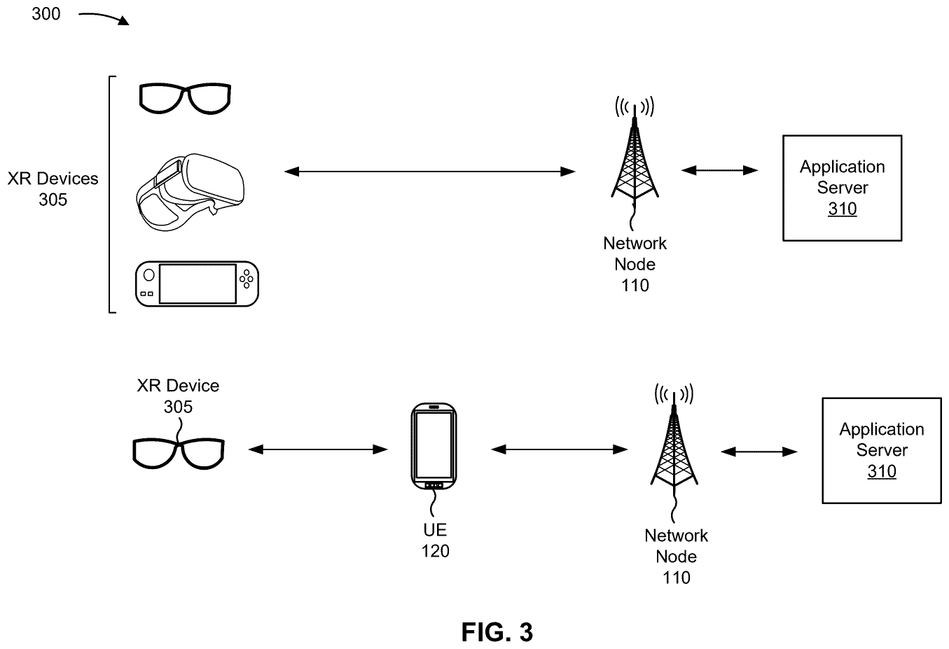

FIG. 3 is a diagram illustrating an example 300 of devices designed for XR traffic applications, in accordance with the present disclosure. As shown in FIG. 3, an XR device 305 may communicate with an application server 310.

In some aspects, the XR device 304 may communicate with the application server 310 through a UE 120 that communicates with a network node 110 in a wireless communication network (e.g., wireless communication network 100). Here, the UE 120 may be communicatively connected with the XR device 305 by a wired (e.g., universal serial bus (USB), serial ATA (SATA)) and/or a wireless (e.g., Bluetooth, Wi-Fi, 5G) connection.

In some aspects, the XR device 305 communicates with the application server 310 without the use of an intermediate UE 120. Here, the XR device 305 communicates wirelessly with a network node 110 in the wireless network 100 to communicate with the application server 310.

As indicated above, an application server 310 may host an application (e.g., an XR application or an application that has XR support). A UE 120 or an XR device 305 may execute an application client that communicates with the application hosted by the application server 310. Applications for an XR device 305 (or for another type of gaming device such as a UE 120) may include a video game (e.g., where multimedia traffic is transferred to and from the application server 310 at a particular frame rate to support audio and/or video rendering) and/or a VR environment (e.g., where multimedia traffic is transferred to and from the application server 310 at a particular polling rate to support sensor input (e.g., 6 degrees of freedom (6DOF) sensor input and feedback), among other examples. Some applications, including applications for XR, VR, AR, and/or gaming, may require low-latency traffic to and from an edge server or a cloud environment. The traffic to and from the edge server or the cloud environment may be periodic, to support a particular frame rate (e.g., 120 frames per second (FPS), 90 FPS, 60 FPS), a particular refresh rate (e.g., 500 Hertz (Hz), 120 Hz), and/or a particular data transfer rate (e.g., 8 megabits per second (Mbps), 30 Mbps, 45 Mbps) for XR traffic applications.

As indicated above, FIG. 3 is provided as an example. Other examples may differ from what is described with regard to FIG. 3.

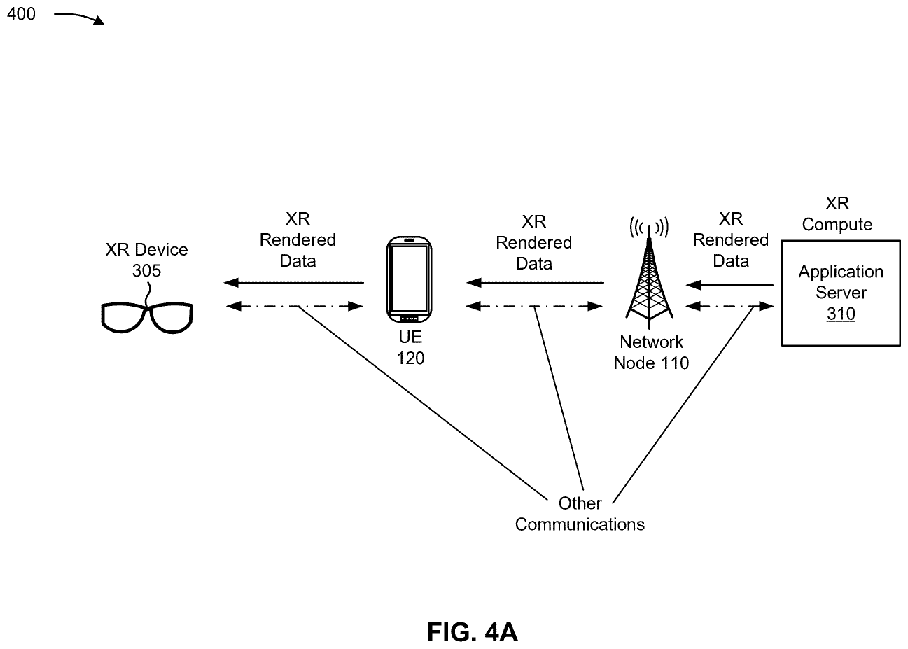

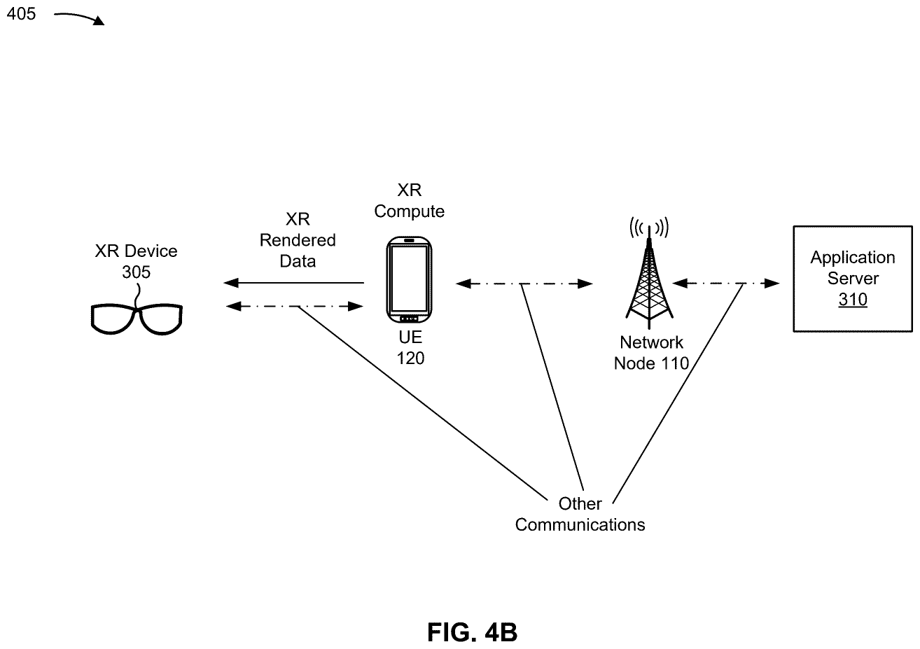

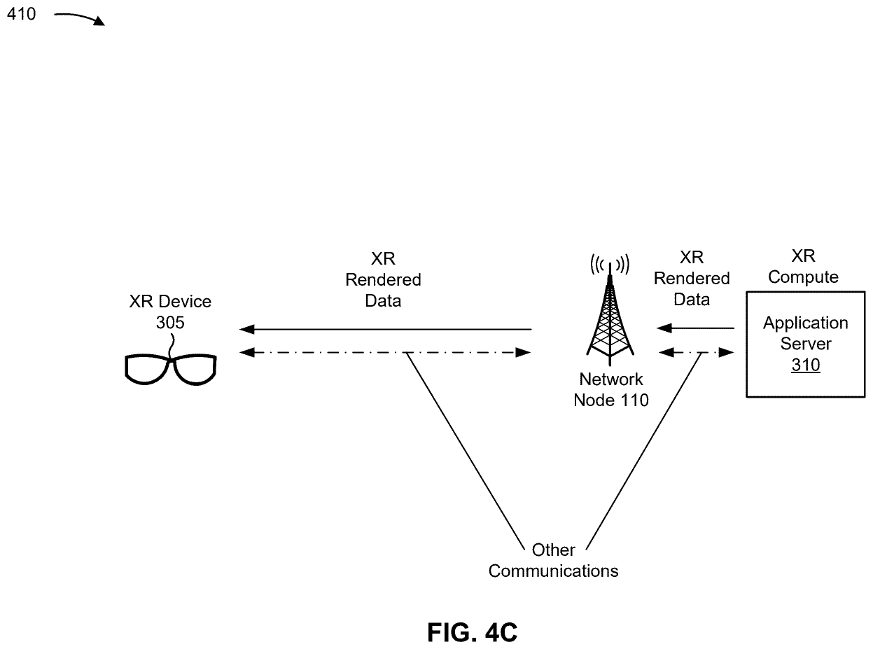

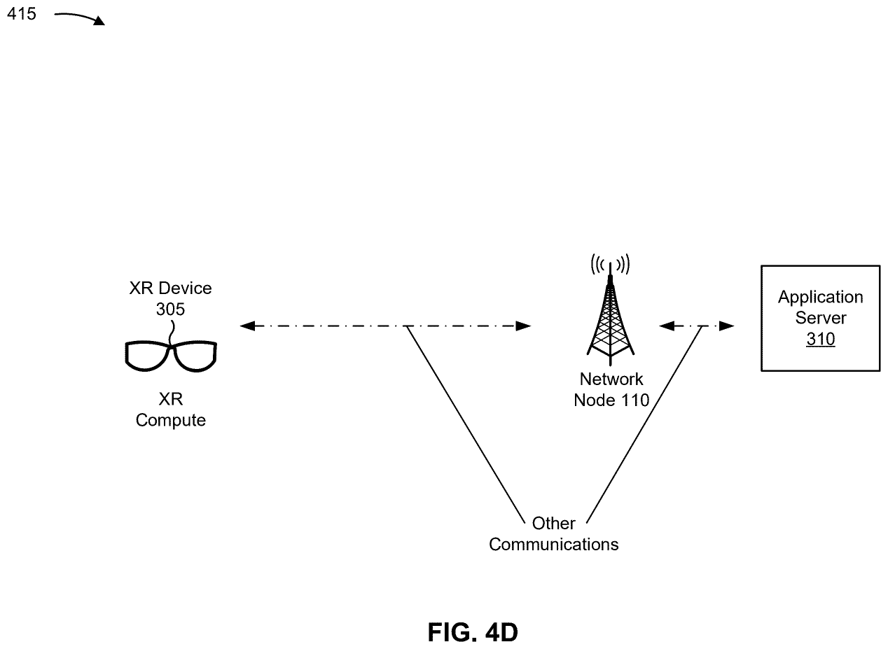

FIGS. 4A-4D are diagrams of examples of distributed XR compute, in accordance with the present disclosure. As shown in FIGS. 4A-4D, the examples of distributed XR compute may include an XR device 305, a UE 120, a network node 110, and/or an application server 310, among other examples.

Determining an XR compute location for XR data, as described herein, refers to determining or selecting the device that is to perform the XR compute of the XR data. Thus, if the XR compute location is determined to be the UE 120, the UE 120 is to perform the XR compute of the XR data. Alternatively, if the XR compute location is determined to be the application server 310, the application server 310 is to perform the XR compute of the XR data.

FIG. 4A illustrates an example 400 of distributed XR compute. As shown in FIG. 4A, an XR device 305 may communicate with a UE 120. The UE 120 may communicate with a network node 110. The network node 110 may communicate with an application server 310. Accordingly, the XR device 305 may communicate with the application server 310 through the UE 120 and the network node 110, and the UE 120 may communicate with the application server 310 through the network node 110.

As further shown in FIG. 4A, XR compute of XR data (e.g., associated with an application hosted by the application server 310 and associated with an application client on the XR device 305 and/or on the UE 120) may be performed by the application server 310. The XR data may include raw video data (e.g., data that is to be used to generate a video stream), among other examples. Thus, in the example 400, the XR compute location is the application server 310. The application server 310 performs XR compute of the XR data, and provides XR rendered data (e.g., a rendered video stream, a rendered audio stream) to the XR device 305 through the network node 110 and through the UE 120. The UE 120 acts as a passthrough in that the UE 120 forwards or relays the XR rendered data to the XR device 305, which is tethered to the UE 120. The connection between the XR device 305 and the UE 120 need not be only tethering; other type of connections, such as Wi-Fi, may also be used.

Other types of communications, in addition to the XR rendered data, may be transmitted and received by the network node 110, the UE 120, the XR device 305, and/or the application server 310. For example, the application server 310 may provide, to the UE 120, aggregated application information and/or another type of application information that supports the XR compute of XR data at the UE 120 and/or the XR device 305. As another example, downlink communications and/or uplink communications may be exchanged by the network node 110, the UE 120, the XR device 305, and/or the application server 310.

FIG. 4B illustrates another example 405 of distributed XR compute. An XR device 305 may communicate with a UE 120. The UE 120 may communicate with a network node 110. The network node 110 may communicate with an application server 310. Accordingly, the XR device 305 may communicate with the application server 310 through the UE 120 and the network node 110, and the UE 120 may communicate with the application server 310 through the network node 110.

As further shown in FIG. 4B, XR compute of XR data may be performed by the UE 120 associated with the XR device 305. Thus, in the example 405, the XR compute location is the UE 120. In some implementations, the application server 310 provides an indication to the UE 120 through the network node 110 to perform XR compute for the XR device 305. The UE 120 receives the indication and performs XR compute of the XR data. The UE 120 provides XR rendered data to the XR device 305.

While the XR rendered data is provided from the UE 120 to the XR device 305, other types of communications may be exchanged between the network node 110, the UE 120, the XR device 305, and/or the application server 310. For example, the application server 310 may provide, to the UE 120, aggregated application information and/or another type of application information that supports the XR compute of XR data at the UE 120. As another example, downlink communications and/or uplink communications may be exchanged by the network node 110, the UE 120, the XR device 305, and/or the application server 310.

FIG. 4C illustrates another example 410 of distributed XR compute. As shown in FIG. 4C, an XR device 305 may communicate with an application server 310 through a network node 110. The XR device 305 may communicate directly with the network node 110 (e.g., without communicating through an associated UE 120).

As further shown in FIG. 4C, XR compute of XR data may be performed by the application server 310. Thus, in the example 410, the XR compute location is the application server 310. The application server 310 performs XR compute of the XR data, and provides XR rendered data to the XR device 305 through the network node 110.

Other types of communications, in addition to the XR rendered data, may be transmitted and received by the network node 110, the XR device 305, and/or the application server 310. For example, the application server 310 may provide, to the XR device 305, aggregated application information and/or another type of application information that supports the XR compute of XR data at the XR device 305. As another example, downlink communications and/or uplink communications may be exchanged by the network node 110, the XR device 305, and/or the application server 310.

FIG. 4D illustrates another example 415 of distributed XR compute. An XR device 305 may communicate with an application server 310 through a network node 110. The XR device 305 may communicate directly with the network node 110 (e.g., without communicating through an associated UE 120).

As further shown in FIG. 4D, XR compute of XR data may be performed by the XR device 305. Thus, in the example 415, the XR compute location is the XR device 305. The application server 310 provides an indication to the XR device 305 through the network node 110 to perform XR compute for the XR device 305. The XR device 305 receives the indication from the application server 310 through the network node 110.

While the XR rendered data is generated at the XR device 305, other types of communications may be exchanged between the network node 110, the XR device 305, and/or the application server 310. For example, the application server 310 may provide, to the XR device 305, aggregated application information and/or another type of application information that supports the XR compute of XR data at the XR device 305. As another example, downlink communications and/or uplink communications may be exchanged by the network node 110, the XR device 305, and/or the application server 310.

As indicated above, FIGS. 4A-4D are provided as examples. Other examples may differ from what is described with regard to FIGS. 4A-4D.

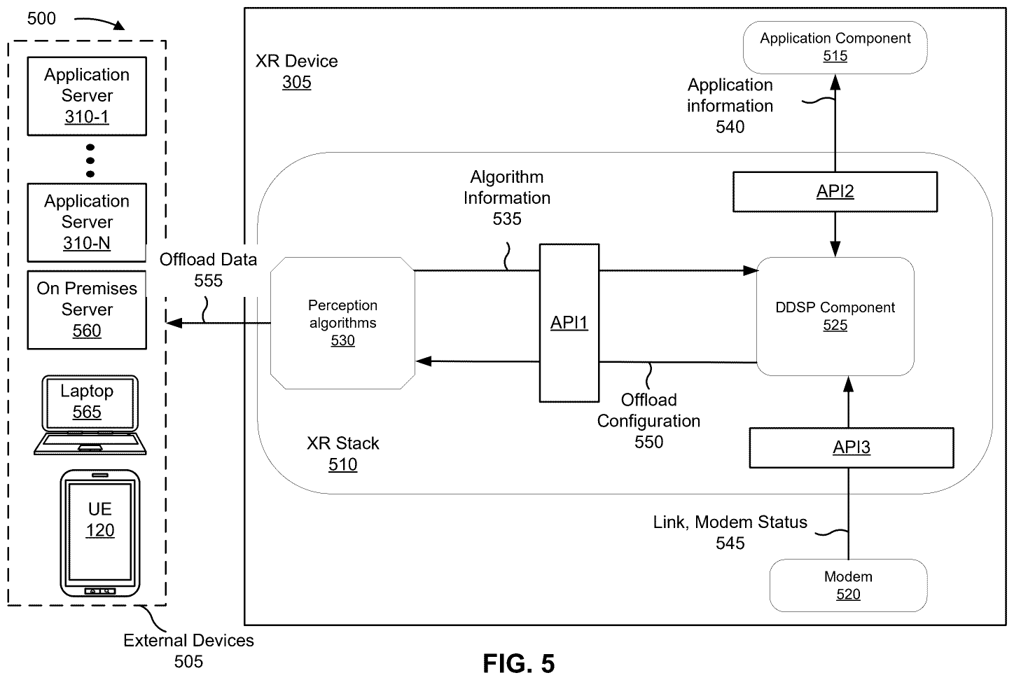

FIG. 5 is a diagram of an example 500 of dynamic distributed split perception, in accordance with the present disclosure. As shown in FIG. 5, the example 500 of dynamic distributed split perception may include an XR device 305 and group of external devices 505.

As shown in FIG. 5, the XR device 305 may include an XR stack 510, an application component 515, and a modem 520, among other examples. In some aspects, a dynamic distributed split perception (DDPS) component 525 and a perception algorithms component 530 may be configured within the XR stack 510 (e.g., rather than in the application component 515). In some aspects, including the DDPS component 525 may simplify implementation of the DDPS component 525 relative to the DDPS component 525 being configured within the application component 515. For example, as described in greater detail below, information utilized by the DDPS component 525 to determine a compute location for perception data may be provided by the perception algorithms component 530, which is also configured within the XR stack 510.

In some aspects, the XR stack 510 may include one or more application programming interfaces (APIs) configured to enable the communication of information between the DDPS component 525 and other components of the XR device 305. For example, as shown in FIG. 5, the XR stack 510 may include a first API (e.g., API1, as shown in FIG. 5) between the DDPS component 525 and the perception algorithms component 530, a second API (e.g., API2, as shown in FIG. 5) between the DDPS component 525 and the application component 515, and a third API (e.g., API3, as shown in FIG. 5) between the DDPS component 525 and the modem 520.

As shown by reference number 535, the perception algorithms component 530 may provide algorithm information to the DDPS component 525. For example, the perception algorithms component 530 may provide algorithm information to the DDPS component 525 via the first API.

In some aspects, the algorithm information may include information associated with performing one or more tasks using a perception algorithm. In some aspects, the algorithm information may indicate one or more tasks for which the DDPS component 525 is to determine a compute location. For example, the algorithm information may indicate a task associated with depth maps, 3D rendering, and/or semantic segmentation, among other examples. In some aspects, the algorithm information may comprise a primary input for initiating the DDPS component 525 to determine a compute location.

In some aspects, the algorithm information may indicate a tasks dependency graph associated with the one or more tasks. In some aspects, the tasks dependency graph may indicate a dependency relationship between separate tasks. For example, the tasks dependency graph may indicate that a 3D rendering computation utilizes (e.g., depends on) an output of one or more depth maps and/or a semantic segmentation computation.

In some aspects, the XR compute location for a particular task may be based at least in part on the tasks dependency graph. For example, in aspects where the tasks dependency graph indicates that the 3D rendering computation depends on an output of one or more depth maps and/or a semantic segmentation computation, the DDPS component 525 may determine a same XR compute location for the 3D rendering, the one or more depth maps, and/or the semantic segmentation computation

In some aspects, the algorithm information indicates a load of an input and an output (e.g., in megabytes per second (Mbps) and a rate at which data is to be rendered (e.g., in frames per second). For example, the algorithm information may indicate that offloading depth maps requires 12 Mbps on an uplink channel receiving an output requires 10 Mbps on a downlink channel. In some aspects, the DDPS component 525 utilizes the load of the input and the output to determine the required throughput and/or an amount of power utilized for communicating a task to an external device 505 and receiving an output from the external device 505.

In some aspects, the algorithm information may indicate a local compute power associated with performing the task locally (e.g., on the XR device 305). For example, the algorithm information may indicate that running depth maps locally may consume 610 milliwatts (mW) of power. In some aspects, the DDPS component 525 may determine an amount of power that can be conserved by the XR device 305 by offloading a task based at least in part on the local compute power associated with performing the task locally.

In some aspects, the algorithm information may indicate a maximum tolerated round trip time (RTT) associated with offloading a task to an external device. For example, the algorithm information may indicate that depths maps may need to be generated every 200 milliseconds (msec).

In some aspects, the DDPS component 525 may determine an XR compute location for a task based at least in part on the maximum tolerated RRT. In some aspects, the DDPS component 525 may perform a discovery process to identify a set of application servers 310 (e.g., shown as application servers 310-1 through 310-N in FIG. 5) and/or to obtain capability information for the set of application servers 310.

In some aspects, the capability information may indicate an address (e.g., an IP address, a MAC address) associated with each application server 310, a set of available services available on each application server 310, a compute power of each application server 310, a load of each application server 310, and/or an amount of available power associated with the each application server 310. In some aspects, the DDPS component 525 may identify an application server 310 associated with associated with characteristics that indicate that offloading the task to the application server 310 will not result in a violation of the maximum tolerated RTT.

In some aspects, the algorithm information may indicate a required computation complexity associated with a task. For example, the algorithm information may indicate a quantity of processing cores required to perform the task, a type of graphics processing unit (GPU) required to perform the task, and/or an amount of available memory required to perform the task, among other examples. The DDPS component 525 may determine the XR compute location based at least in part on identify a device (e.g., an external device 505, the XR device 305) that satisfies the required computation complexity requirements.

In some aspects, the algorithm information may indicate one or more privacy requirements. For example, the algorithm information may indicate that a task is associated with a perception algorithm that utilizes sensitive user information as an input.

In some aspects, the DDPS component 525 may determine the XR compute location based at least in part on the privacy requirements. For example, the XR compute location as the XR device 301 and/or an external device that is located at a premises of a user associated with the privacy requirements and/or owned by the user (e.g., on premises server 560, laptop 565, and/or UE 120, as shown in FIG. 5).

In some aspects, the DDPS component 525 may determine whether additional processing is to be performed on the perception data based at least in part on the privacy requirements. For example, the DDPS component 525 may determine that sensitive user data is to be removed, obscured, and/or replaced with non-sensitive data prior to the task being offloaded to an external device.

As shown by reference number 540, the DDPS component 525 and the application component 515 may communicate application information. For example, the DDPS component 525 and the application component 515 may communicate application information via the second API.

In some aspects, the application information may indicate an available resource for performing a task. For example, the DDPS component 525 may transmit application information indicating that a particular perception algorithm is available, and/or that a particular external device is available to perform a task using the particular perception algorithm, among other examples.

As an example, the DDPS component 525 may transmit application information indicating that depth maps with a resolution of 1024×1024 at 30 fps are available. In some aspects, the application component may modify one or more parameters of the XR application based at least in part on the application information.

In some aspects, the application information transmitted by the application component 515 and to the DDPS component 525 may indicate a perception algorithm and/or task needed by the application component 515. For example, the application information transmitted by the application component 515 and to the DDPS component 525 may indicate that the application component needs depth maps, a 3D rendering, and/or semantic segmentation, among other examples.

In some aspects, the DDPS component 525 may utilize the application information transmitted by the application component 515 to determine an XR compute location for a task. For example, the DDPS component 525 may determine that a task indicated in the application can be performed locally, can be offloaded to an external device 505, and/or can only be performed by a particular external device 505.

In some aspects, the application information transmitted by the application component 515 and to the DDPS component 525 may indicate a preferred external device to be used to perform a task. For example, the XR application may be configured with a pre-defined application server that is to be used to perform a task. The application component 515 may transmit application information indicating the pre-defined application server, the task, and/or that the pre-defined application server is to be used to perform the task to the DDPS component 525.

In some aspects, the DDPS component 525 may determine an XR compute location for the task based at least in part on the application information. For example, the DDPS component 525 may determine that the task is to be offloaded to the pre-defined application server.

In some aspects, the DDPS component 525 may determine the XR compute location for a task based at least in part on information received from the modem 520. As shown by reference number 545, the modem 520 may transmit link and/or modem status information to the DDPS component 525. For example, as shown in FIG. 5, the modem 520 may transmit link and/or modem status information to the DDPS component 525 via the third API.

In some aspects, the link status information may indicate a status and/or a characteristic associated with a communication link used to offload a task to an external device 505. For example, the link status information may indicate whether the communication link is currently operational, a type of network associated with the communication link (e.g., a Wi-Fi network, a cellular network, and/or the like), a capacity of the communication link, an MCS associated with communicating data via the communication link, and/or a number of layers available for communicating data via the communication link, among other examples.

In some aspects, the modem status information may indicate a status of the modem 520. For example, the modem status information may indicate a power saving feature associated with the modem 520, background running tasks, and/or an amount of data currently stored in a queue of the modem 520, among other examples.

In some aspects, the DDPS component 525 may utilize the modem status information to determine whether the communication link can support a required rate associated with offloading a task and/or a power consumption of the modem 520 while offloading the task.

In some aspects, the DDPS component 525 may determine an XR compute location for performing a task based at least in part on the algorithm information, the application information, the link and modem status information, and characteristics of one or more external devices 505 (e.g., characteristics of one or more application servers 310 obtained as a result of performing a discovery process). As described above, determining an XR compute location for XR data refers to determining or selecting the device that is to perform the XR compute of the XR data. Thus, if the DDPS component 525 determines the XR compute location is to be the XR device 305, the DDPS component 525 determines that the XR device 305 is to perform the XR compute of the XR data for the XR device 305. This is referred to as local compute or performing a task locally, and is illustrated in example 405 of FIG. 4B.

Alternatively, if the DDPS component 525 determines the XR compute location to be an external device 505, the DDPS component 525 determines that the external device 505 is to perform the XR compute of the XR data for the XR device 305. This is referred to as remote compute or offloading the task to an external device, and is illustrated in the example 400 of FIG. 4A.

The DDPS component 525 may determine the XR compute location based at least in part on radio conditions between the XR device 305 and the external device 505, based at least in part on power consumption of the XR device 305, based at least in part on a radio condition prediction associated with the XR device 305, and/or based at least in part on another parameter.

The radio conditions between the UE 120 and a network node 110 may correspond to (or may be indicated by) one or more wireless radio parameters associated with the wireless radio link (e.g., the uplink and/or the downlink) between the UE 120 and the network node 110. The one or more wireless radio parameters may include an RSRP on the uplink and/or on the downlink, an RSSI on the uplink and/or on the downlink, an RSRQ on the uplink and/or on the downlink, and/or a CQI on the uplink and/or on the downlink, and/or an enhanced link capacity estimate (eLCE), among other examples. The wireless radio parameters may be based at least in part on input from a modem 254 of the UE 120 and/or based at least in part on another component of the UE 120.

In some aspects, the DDPS component 525 may determine the XR compute location based at least in part on whether a wireless radio parameter satisfies a threshold. For example, the DDPS component 525 may determine the XR compute location to be the application server 310 if an RSRP satisfies (e.g., exceeds, is equal to) an RSRP threshold. As another example, the DDPS component 525 may determine the XR compute location to be the XR device 305 if the RSRP does not satisfy (e.g., is less than, is equal to) the RSRP threshold.

As another example, the DDPS component 525 may determine the XR compute location to be the application server 310 if an eLCE satisfies (e.g., exceeds, is equal to) an eLCE threshold. As another example, the DDPS component 525 may determine the XR compute location to be the XR device 305 if the eLCE does not satisfy (e.g., is less than, is equal to) the eLCE threshold.

The eLCE may refer to an estimated available capacity on the wireless radio link used to communicate data between the DDPS component 525 and an external device 505. The eLCE threshold may be based at least in part on a required bit rate for the application hosted by the application server 310 and the associated application client on the XR device 305. For example, the DDPS component 525 may determine the eLCE threshold to be based at least in part on an approximately 8 Mbps bitrate for a cloud gaming application. As another example, the DDPS component 525 may determine the eLCE threshold to be based at least in part on an approximately 30 Mbps bitrate for an AR application. As another example, the DDPS component 525 may determine the eLCE threshold to be based at least in part on an approximately 45 Mbps bitrate for a VR application.

The power consumption of the XR device 305 may include an estimated power consumption of the XR device 305 for different XR compute locations. As an example, the DDPS component 525 may determine a first estimated power consumption (P_local) of the XR device 305 if the XR compute location were the XR device 305 (e.g., if the XR device 305 were to perform the XR compute for the XR device 305) and a second estimated power consumption (P_remote) of the XR device 305 if the XR compute location is an external device 505 (e.g., if the external device 505 were to perform the XR compute for the XR device 305). The DDPS component 525 may determine the XR compute location to be the XR device 305 if the second estimated power consumption is greater than the first estimated power consumption (e.g., if P_remote>P_local). Alternatively, the DDPS component 525 may determine the XR compute location to be the external device 505 if the first estimated power consumption is greater than the second estimated power consumption (e.g., if P_remote<P_local).

In some aspects, an estimated power consumption may include a combination of an estimated wireless radio power consumption (P_radio) of the XR device 305 and an estimated XR compute power consumption (P_compute) of the XR device 305. The estimated wireless radio power consumption may be a peak wireless radio power consumption, an average wireless radio power consumption, or a combination thereof. The DDPS component 525 may determine the estimated wireless radio power consumption based at least in part on information provided by the modem 520, which may include data rates, transmit power, device delay period, and/or channel utilization, among other parameters.

In some aspects, the estimated XR compute power consumption may be a peak XR compute power consumption, an average XR compute power consumption, or a combination thereof. The DDPS component 525 may determine the estimated XR compute power consumption based at least in part on a type of compute tasks that are to be performed for XR compute, and/or historical measurements of power consumption for the compute tasks for the controller/processor of the XR device 305 (e.g., the central processing unit (CPU) of the XR device 305, the graphics processing unit (GPU) of the XR device 305).

The DDPS component 525 may determine an estimated power consumption (e.g., P_local, P_remote) based at least in part on the estimated wireless radio power consumption and the estimated XR compute power consumption (e.g., P_radio+P_compute). In particular, the DDPS component 525 may determine the first estimated power consumption as P_local=P_radio_local+P_compute_local, and may determine the second estimated power consumption as P_remote=P_radio_remote+P_compute_remote.

In some aspects, the DDPS component 525 may determine the XR compute location based at least in part on other parameters, such as a packet loss rate between the application client at the XR device 305 and the network node 110, an RTT between the application client at the XR device 305 and the network node 110, a server load associated with the application server 310, and/or a network load associated with the network node 110, among other examples.

For example, the DDPS component 525 may determine the XR compute location to be the XR device 305 if the packet loss rate satisfies (e.g., exceeds, is equal to) a package loss rate threshold. As another example, the DDPS component 525 may determine the XR compute location to be an external device 505 if the packet loss rate does not satisfy (e.g., is less than, is equal to) the package loss rate threshold.

As another example, the DDPS component 525 may determine the XR compute location to be the XR device 305 if the RTT satisfies (e.g., exceeds, is equal to) an RTT threshold. As another example, the DDPS component 525 may determine the XR compute location to be an external device 505 if the RTT does not satisfy (e.g., is less than, is equal to) the RTT threshold.

As another example, the DDPS component 525 may determine the XR compute location to be the XR device 305 if a load of the external device 505 satisfies (e.g., exceeds, is equal to) a server load threshold. As another example, the DDPS component 525 may determine the XR compute location to be the external device 505 if the server load does not satisfy (e.g., is less than, is equal to) the server load threshold. Generally, the greater the server load, the fewer the resources that are available to be allocated to the XR device 305, which may result in increased delays even if radio conditions on the wireless radio link between the XR device 305 and the network node 110 are satisfactory.

As another example, the DDPS component 525 may determine the XR compute location to be the XR device 305 if the network load satisfies (e.g., exceeds, is equal to) a network load threshold. As another example, the DDPS component 525 may determine the XR compute location to be an external device 505 if the network load does not satisfy (e.g., is less than, is equal to) the network load threshold. Generally, the greater the network load, the fewer the resources that are available to be allocated to the XR device 305, which may result in increased delays even if radio conditions on the wireless radio link between the XR device 305 and the network node 110 are satisfactory.

In some aspects, the DDPS component 525 may determine the XR compute location based at least in part on a combination of the above-described parameters (and/or other parameters). For example, the DDPS component 525 may assign appropriate weights to one or more of the parameters and may determine the XR compute location based at least in part on the weighted parameters. As an example, even if radio conditions on the wireless radio link between the XR device 305 at the network node 110 degrade, the DDPS component 525 may still maintain the XR compute location to be the external device 505 if power consumption at the XR device 305 is greater if the XR device 305 performs the XR compute than the power consumption at the XR device 305 if the external device 505 performs the XR compute (e.g., if (P_remote<P_local).

As shown by reference number 550, the DDPS component 525 may transmit a offload configuration to the perception algorithms component 530. For example, as shown in FIG. 5, the DDPS component 525 may transmit the offload configuration to the perception algorithms component 530 via the first API.

In some aspects, the offload configuration may indicate an XR compute location for a task, a portion of a task, and/or a group of tasks. In some aspects, the XR offload configuration may indicate, for each task indicated in the algorithm information, whether the task (or a portion of a task) is to be offloaded to an external device, to multiple external device, or performed locally by the XR device 305.

In some aspects, the offload configuration may include an identifier or other information that can be used to identify an external device to which a task (or a portion of a task) is to be offloaded. For example, the offload configuration may indicate that a first portion of a task is to be performed locally by the XR device 305. The offload configuration may indicate that a second portion of the task is to be performed at the application server 310. The offload configuration may indicate that a third portion of the task is to be performed at the on-premises server 560.

In some aspects, the offload configuration may indicate one or more algorithm parameters associated with performing a task. For example, the offload configuration information may indicate that a task is to be performed at the application server 310 and that the application server 310 is to run the task at X frames per second and at Y resolution.

As shown by reference number reference number 555, the perception algorithms component 530 may selectively transmit an indication of the XR compute location to one or more devices, such as the application server 310, the on premises server 560, the laptop 565, and/or the UE 120.

As indicated above, FIG. 5 is provided as an example. Other examples may differ from what is described with regard to FIG. 5.

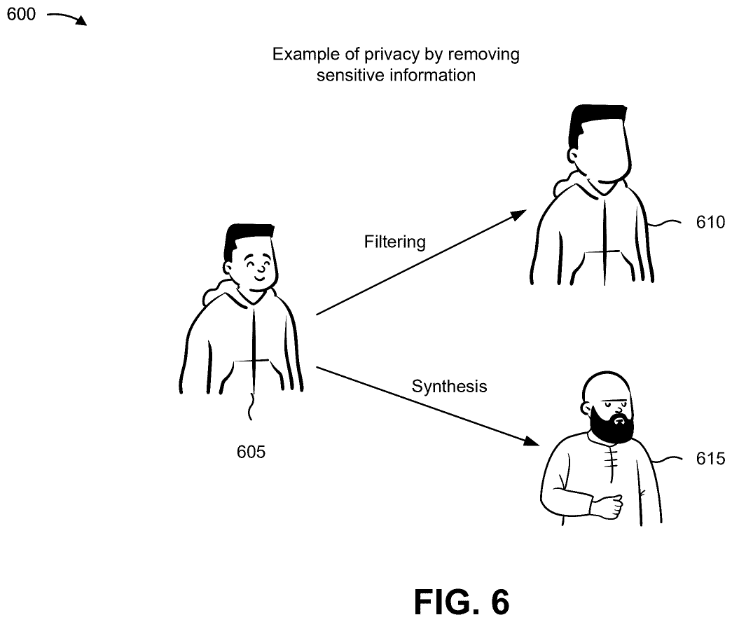

FIG. 6 is a diagram of an example 600 associated with an offloading/split decision framework, in accordance with the present disclosure. As shown in FIG. 6, example 600 includes perception data that includes sensitive user information. For example, as shown in FIG. 6, the sensitive user information may include an image 605 of a user.

A perception algorithm may operate on inputs that might contain sensitive user information, such as information indicating a location of the user, images of a user's home, and/or the like. In some aspects, a DDPS component may determine that offloading the perception algorithm to an external device including transmitting the sensitive user information to the external device, which may violate one or more privacy constraints.

In some aspects, the DDPS component may ensure that each determination of a XR compute location complies with all user privacy requirements. For example, the DDPS component may determine to offload a perception algorithm that operates on inputs that might contain sensitive user information only to local servers owned by the user (e.g., an on premise server, an XR PUCK, a user's phone/laptop, and/or the like).

In some aspects, the DDPS component may determine not to offload a task based at least in part on the devices to which the task can be offloaded (e.g., local servers owned by the user) being insufficient to perform the task. For example the devices may not have the required compute resources, may not be able to satisfy an RTT requirement, and/or the like.

In some aspects, the DDPS component may determine to removing the sensitive user information from the input before offloading the input to the external device. For example, the DDPS component may cause a face of the user to be blurred or filtered as shown by reference number 610. As another example, the DDPS component may replace the face of the user with a synthesized fake face, as shown by reference number 615.

In some aspects, the perception algorithm may utilize a machine learning model (e.g., a neural network). In some aspects, the DDPS component may cause a portion of the machine learning model to run locally on the XR device to generate a feature vector. The DDPS component may cause the feature vector to be transmitted to the external device. The external device may receive the feature vector and may utilize the feature vector to continue the performance of the task. In this way, the DDPS component may balance privacy concerns with power conservation.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with dynamic distributed split perception.

As shown in FIG. 7, in some aspects, process 700 may include receiving one or more parameters associated with computing perception data for an XR application (block 710). For example, the UE (e.g., using reception component 802 and/or communication manager 806, depicted in FIG. 8) may receive one or more parameters associated with computing perception data for an XR application, as described above.

As further shown in FIG. 7, in some aspects, process 700 may include transmitting computing information indicating whether an external device is to perform one or more tasks associated with computing the perception data, wherein a determination of whether the external device is to perform the one or more tasks is based at least in part on the one or more parameters (block 720). For example, the UE (e.g., using transmission component 804 and/or communication manager 806, depicted in FIG. 8) may transmit computing information indicating whether an external device is to perform one or more tasks associated with computing the perception data, wherein a determination of whether the external device is to perform the one or more tasks is based at least in part on the one or more parameters, as described above.

Process 700 may include additional aspects, such as any single aspect or any combination of aspects described below and/or in connection with one or more other processes described elsewhere herein.

In a first aspect, the computing information includes information identifying the external device based at least in part on the computing information indicating that the external device is to perform at least one of the one or more tasks.

In a second aspect, alone or in combination with the first aspect, the computing information includes information identifying a component of the UE based at least in part on the computing information indicating that the external device is not to perform at least one of the one or more tasks.

In a third aspect, alone or in combination with one or more of the first and second aspects, process 700 includes determining, within an XR stack, whether the external device is to perform the one or more tasks associated with computing the perception data.

In a fourth aspect, alone or in combination with one or more of the first through third aspects, the one or more tasks associated with computing the perception data comprises a plurality of tasks.

In a fifth aspect, alone or in combination with one or more of the first through fourth aspects, process 700 includes determining, for each task of the plurality of tasks, whether the external device is to perform the task.

In a sixth aspect, alone or in combination with one or more of the first through fifth aspects, process 700 includes determining, for a task of the plurality of tasks, whether the external device is to perform a portion of the task.

In a seventh aspect, alone or in combination with one or more of the first through sixth aspects, the external device comprises a plurality of external devices.

In an eighth aspect, alone or in combination with one or more of the first through seventh aspects, the one or more parameters comprise one or more of privacy of a user associated with the perception data, a task that is a dependent task relative to the one or more tasks, a dependency relationship between the one or more tasks, a dependency relationship between the one or more tasks and another task associated with computing the perception data, one or more parameters associated with the external device, one or more parameters associated with a communication link established between the UE and the external device, or an application requirement associated with the XR application.

In a ninth aspect, alone or in combination with one or more of the first through eighth aspects, the one or more parameters are received via an API associated with communicating data between a first component configured to determine whether the external device is to perform the one or more tasks and a second component configured to compute the perception data.

In a tenth aspect, alone or in combination with one or more of the first through ninth aspects, the computing information indicates that a task, of the one or more tasks, is to be performed by the external device and information indicating a communication link associated with communicating information with the external device, one or more parameters associated with the communication link, one or more parameters associated with an algorithm to be used by the external device to perform the task, or a combination thereof.

In an eleventh aspect, alone or in combination with one or more of the first through tenth aspects, process 700 includes receiving, by the first component and via the API, information indicating the one or more tasks.

In a twelfth aspect, alone or in combination with one or more of the first through eleventh aspects, the one or more tasks are associated with a depth map, a three-dimensional representation, a semantic segmentation, or a combination thereof.

In a thirteenth aspect, alone or in combination with one or more of the first through twelfth aspects, the one or more parameters include a tasks dependency graph, a load of an input, a load of an output, a frame rate, an amount of power associated with performing the one or more tasks, a maximum round trip time associated with the external device performing the one or more tasks, a computation complexity associated with performing the one or more tasks, a privacy requirement associated with the one or more tasks, or a combination thereof.

In a fourteenth aspect, alone or in combination with one or more of the first through thirteenth aspects, the one or more parameters are received via an API associated with communicating data between a first component configured to determine whether the external device is to perform the one or more tasks and the XR application.

In a fifteenth aspect, alone or in combination with one or more of the first through fourteenth aspects, process 700 includes transmitting, to the XR application and via the API, an indication of a type of perception algorithm available on the external device.

In a sixteenth aspect, alone or in combination with one or more of the first through fifteenth aspects, process 700 includes receiving, from the XR application and via the API, an indication of the one or more tasks, a type of perception algorithm associated with performing the one or more tasks, a quality metric associated with the one or more tasks, a preferred external device for performing the one or more tasks, or a combination thereof.

In a seventeenth aspect, alone or in combination with one or more of the first through sixteenth aspects, the indication of the one or more tasks includes an indication of a depth map, a three-dimensional representation, a semantic segmentation, or a combination thereof.

In an eighteenth aspect, alone or in combination with one or more of the first through seventeenth aspects, the indication of the quality metric includes an indication of a frame rate, a resolution, a privacy requirement, or a combination thereof.

In a nineteenth aspect, alone or in combination with one or more of the first through eighteenth aspects, the one or more parameters are received via an API associated with communicating data between a first component configured to determine whether the external device is to perform the one or more tasks and a modem of the UE.

In a twentieth aspect, alone or in combination with one or more of the first through nineteenth aspects, process 700 includes receiving, from the modem and via the API, information associated with communicating data between the UE and the external device, information indicating a status of the modem, or a combination thereof.

In a twenty-first aspect, alone or in combination with one or more of the first through twentieth aspects, the information associated with communicating the data between the UE and the external device includes information indicating a type of network via which the data is communicated, a type of communication link via which the data is communicated, a capacity of the communication link, an MCS associated with communicating the data, a quantity of layers available for communicating the data, information indicating a power consumption of the modem associated with the external device performing the one or more tasks, or a combination thereof.

In a twenty-second aspect, alone or in combination with one or more of the first through twenty-first aspects, the information indicating the status of the modem includes information indicating a power saving feature of the modem, information associated with background running tasks, information indicating whether a communication link via which the data is to be transmitted supports using the external device to perform the one or more tasks, information indicating a power consumption of the modem associated with the external device performing the one or more tasks, or a combination thereof.

In a twenty-third aspect, alone or in combination with one or more of the first through twenty-second aspects, process 700 includes receiving information associated with a group of external devices based at least in part on performing a discovery process, wherein the group of external devices includes the external device.

In a twenty-fourth aspect, alone or in combination with one or more of the first through twenty-third aspects, the information associated with the group of external devices includes information indicating an internet protocol (IP) address associated with one or more external devices included in the group of external devices, a service available to be provided by the one or more external devices, a compute power associated with the one or more external devices, a load associated with the one or more external devices, an amount of available power associated with the one or more external devices, a type of power source utilized by the one or more external devices, or a combination thereof.

In a twenty-fifth aspect, alone or in combination with one or more of the first through twenty-fourth aspects, process 700 includes transmitting, to the external device, an algorithm associated with performing the one or more tasks.

In a twenty-sixth aspect, alone or in combination with one or more of the first through twenty-fifth aspects, the algorithm is included in a container to be run on the external device to perform the one or more tasks.

In a twenty-seventh aspect, alone or in combination with one or more of the first through twenty-sixth aspects, a determination of whether the external device is to perform the one or more tasks is based at least in part on a metric associated with a communication link for communicating data between the UE and the external device, a quality of experience metric, a privacy constraint, a tasks dependency graph, an availability of the external device, a capability of the external device, an application requirement associated with the one or more tasks, or a combination thereof.

In a twenty-eighth aspect, alone or in combination with one or more of the first through twenty-seventh aspects, the capability of the external device comprises a compute power of the external device, a load of the external device, an amount of available power associated with the external device, or a combination thereof.

In a twenty-ninth aspect, alone or in combination with one or more of the first through twenty-eighth aspects, the application requirement comprises a resolution, a preferred external device, a frame rate, or a combination thereof.

In a thirtieth aspect, alone or in combination with one or more of the first through twenty-ninth aspects, a determination of whether the external device is to perform the one or more tasks is based at least in part on minimizing a power consumption of the UE.

In a thirty-first aspect, alone or in combination with one or more of the first through thirtieth aspects, a determination of whether the external device is to perform the one or more tasks is based at least in part on a likelihood of an input to an algorithm used to compute the perception data includes sensitive user information, whether the external device is a device of a user that is using the XR application, or a combination thereof.

In a thirty-second aspect, alone or in combination with one or more of the first through thirty-first aspects, an input to an algorithm used to compute the perception data includes sensitive user information, the method further comprising generating a modified input based at least in part on removing the sensitive user information from the input, inserting generic user information into the input, or a combination thereof, and transmitting the modified input to the external device.

In a thirty-third aspect, alone or in combination with one or more of the first through thirty-second aspects, an input to an algorithm used to compute the perception data includes sensitive user information, and wherein the computing information indicates that a first task, of the one or more tasks, that is associated with the algorithm and the input is to be performed by the UE and that a second task, of the one or more tasks, that does not utilize the input, is to be performed by the external device.

In a thirty-fourth aspect, alone or in combination with one or more of the first through thirty-third aspects, process 700 includes transmitting a result of performing the first task to the external device to enable the external device to perform the second task.

In a thirty-fifth aspect, alone or in combination with one or more of the first through thirty-fourth aspects, the first task comprises running a portion of a machine learning model to generate the result.

In a thirty-sixth aspect, alone or in combination with one or more of the first through thirty-fifth aspects, the result comprises a feature vector corresponding to an input of a subsequent portion of the machine learning model.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 5. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive one or more parameters associated with computing perception data for an XR application. The transmission component 804 may transmit computing information indicating whether an external device is to perform one or more tasks associated with computing the perception data, wherein a determination of whether the external device is to perform the one or more tasks is based at least in part on the one or more parameters.

The communication manager 806 may determine, within an XR stack, whether the external device is to perform the one or more tasks associated with computing the perception data.

The communication manager 806 may determine, for each task of the plurality of tasks, whether the external device is to perform the task.

The communication manager 806 may determine, for a task of the plurality of tasks, whether the external device is to perform a portion of the task.

The reception component 802 may receive, via the API, information indicating the one or more tasks.

The transmission component 804 may transmit, to the XR application and via the API, an indication of a type of perception algorithm available on the external device.

The reception component 802 may receive, from the XR application and via the API, an indication of the one or more tasks, a type of perception algorithm associated with performing the one or more tasks, a quality metric associated with the one or more tasks, a preferred external device for performing the one or more tasks, or a combination thereof.

The reception component 802 may receive, from the modem and via the API, information associated with communicating data between the UE and the external device, information indicating a status of the modem, or a combination thereof.

The reception component 802 may receive information associated with a group of external devices based at least in part on performing a discovery process, wherein the group of external devices includes the external device.

The transmission component 804 may transmit, to the external device, an algorithm associated with performing the one or more tasks.

The transmission component 804 may transmit a result of performing the first task to the external device to enable the external device to perform the second task.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a UE, comprising: receiving one or more parameters associated with computing perception data for an XR application; and transmitting computing information indicating whether an external device is to perform one or more tasks associated with computing the perception data, wherein a determination of whether the external device is to perform the one or more tasks is based at least in part on the one or more parameters.
Aspect 2: The method of Aspect 1, wherein the computing information includes information identifying the external device based at least in part on the computing information indicating that the external device is to perform at least one of the one or more tasks.
Aspect 3: The method of any of Aspects 1-2, wherein the computing information includes information identifying a component of the UE based at least in part on the computing information indicating that the external device is not to perform at least one of the one or more tasks.
Aspect 4: The method of any of Aspects 1-3, further comprising: determining, within an XR stack, whether the external device is to perform the one or more tasks associated with computing the perception data.
Aspect 5: The method of any of Aspects 1-4, wherein the one or more tasks associated with computing the perception data comprises a plurality of tasks.
Aspect 6: The method of Aspect 5, further comprising: determining, for each task of the plurality of tasks, whether the external device is to perform the task.
Aspect 7: The method of Aspect 5, further comprising: determining, for a task of the plurality of tasks, whether the external device is to perform a portion of the task.
Aspect 8: The method of any of Aspects 1-7, wherein the external device comprises a plurality of external devices.
Aspect 9: The method of any of Aspects 1-8, wherein the one or more parameters comprise one or more of privacy of a user associated with the perception data, a task that is a dependent task relative to the one or more tasks, a dependency relationship between the one or more tasks, a dependency relationship between the one or more tasks and another task associated with computing the perception data, one or more parameters associated with the external device, one or more parameters associated with a communication link established between the UE and the external device, or an application requirement associated with the XR application.
Aspect 10: The method of any of Aspects 1-9, wherein the one or more parameters are received via an API associated with communicating data between a first component configured to determine whether the external device is to perform the one or more tasks and a second component configured to compute the perception data.
Aspect 11: The method of Aspect 10, wherein the computing information indicates that a task, of the one or more tasks, is to be performed by the external device and information indicating a communication link associated with communicating information with the external device, one or more parameters associated with the communication link, one or more parameters associated with an algorithm to be used by the external device to perform the task, or a combination thereof.
Aspect 12: The method of Aspect 10, further comprising: receiving, by the first component and via the API, information indicating the one or more tasks.
Aspect 13: The method of any of Aspects 1-12, wherein the one or more tasks are associated with a depth map, a three-dimensional representation, a semantic segmentation, or a combination thereof.
Aspect 14: The method of any of Aspects 1-13, wherein the one or more parameters include a tasks dependency graph, a load of an input, a load of an output, a frame rate, an amount of power associated with performing the one or more tasks, a maximum round trip time associated with the external device performing the one or more tasks, a computation complexity associated with performing the one or more tasks, a privacy requirement associated with the one or more tasks, or a combination thereof.
Aspect 15: The method of any of Aspects 1-14, wherein the one or more parameters are received via an API associated with communicating data between a first component configured to determine whether the external device is to perform the one or more tasks and the XR application.
Aspect 16: The method of Aspect 15, further comprising: transmitting, to the XR application and via the API, an indication of a type of perception algorithm available on the external device.
Aspect 17: The method of Aspect 15, further comprising: receiving, from the XR application and via the API, an indication of the one or more tasks, a type of perception algorithm associated with performing the one or more tasks, a quality metric associated with the one or more tasks, a preferred external device for performing the one or more tasks, or a combination thereof.
Aspect 18: The method of Aspect 17, wherein the indication of the one or more tasks includes an indication of a depth map, a three-dimensional representation, a semantic segmentation, or a combination thereof.
Aspect 19: The method of Aspect 17, wherein the indication of the quality metric includes an indication of a frame rate, a resolution, a privacy requirement, or a combination thereof.
Aspect 20: The method of any of Aspects 1-19, wherein the one or more parameters are received via an API associated with communicating data between a first component configured to determine whether the external device is to perform the one or more tasks and a modem of the UE.
Aspect 21: The method of Aspect 20, further comprising: receiving, from the modem and via the API, information associated with communicating data between the UE and the external device, information indicating a status of the modem, or a combination thereof.
Aspect 22: The method of Aspect 21, wherein the information associated with communicating the data between the UE and the external device includes information indicating a type of network via which the data is communicated, a type of communication link via which the data is communicated, a capacity of the communication link, an MCS associated with communicating the data, a quantity of layers available for communicating the data, information indicating a power consumption of the modem associated with the external device performing the one or more tasks, or a combination thereof.
Aspect 23: The method of Aspect 21, wherein the information indicating the status of the modem includes information indicating a power saving feature of the modem, information associated with background running tasks, information indicating whether a communication link via which the data is to be transmitted supports using the external device to perform the one or more tasks, information indicating a power consumption of the modem associated with the external device performing the one or more tasks, or a combination thereof.
Aspect 24: The method of any of Aspects 1-23, further comprising: receiving information associated with a group of external devices based at least in part on performing a discovery process, wherein the group of external devices includes the external device.
Aspect 25: The method of Aspect 24, wherein the information associated with the group of external devices includes information indicating an IP address associated with one or more external devices included in the group of external devices, a service available to be provided by the one or more external devices, a compute power associated with the one or more external devices, a load associated with the one or more external devices, an amount of available power associated with the one or more external devices, a type of power source utilized by the one or more external devices, or a combination thereof.
Aspect 26: The method of any of Aspects 1-25, further comprising: transmitting, to the external device, an algorithm associated with performing the one or more tasks.
Aspect 27: The method of Aspect 26, wherein the algorithm is included in a container to be run on the external device to perform the one or more tasks.
Aspect 28: The method of any of Aspects 1-27, wherein a determination of whether the external device is to perform the one or more tasks is based at least in part on a metric associated with a communication link for communicating data between the UE and the external device, a quality of experience metric, a privacy constraint, a tasks dependency graph, an availability of the external device, a capability of the external device, an application requirement associated with the one or more tasks, or a combination thereof.
Aspect 29: The method of Aspect 28, wherein the capability of the external device comprises a compute power of the external device, a load of the external device, an amount of available power associated with the external device, or a combination thereof.
Aspect 30: The method of Aspect 28, wherein the application requirement comprises a resolution, a preferred external device, a frame rate, or a combination thereof.
Aspect 31: The method of any of Aspects 1-30, wherein a determination of whether the external device is to perform the one or more tasks is based at least in part on minimizing a power consumption of the UE.
Aspect 32: The method of any of Aspects 1-31, wherein a determination of whether the external device is to perform the one or more tasks is based at least in part on a likelihood of an input to an algorithm used to compute the perception data includes sensitive user information, whether the external device is a device of a user that is using the XR application, or a combination thereof.
Aspect 33: The method of any of Aspects 1-32, wherein an input to an algorithm used to compute the perception data includes sensitive user information, the method further comprising: generating a modified input based at least in part on removing the sensitive user information from the input, inserting generic user information into the input, or a combination thereof; and transmitting the modified input to the external device.
Aspect 34: The method of any of Aspects 1-33, wherein an input to an algorithm used to compute the perception data includes sensitive user information, and wherein the computing information indicates that a first task, of the one or more tasks, that is associated with the algorithm and the input is to be performed by the UE and that a second task, of the one or more tasks, that does not utilize the input, is to be performed by the external device.
Aspect 35: The method of Aspect 34, further comprising: transmitting a result of performing the first task to the external device to enable the external device to perform the second task.
Aspect 36: The method of Aspect 35, wherein the first task comprises running a portion of a machine learning model to generate the result.
Aspect 37: The method of Aspect 36, wherein the result comprises a feature vector corresponding to an input of a subsequent portion of the machine learning model.
Aspect 38: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-37.
Aspect 39: An apparatus for wireless communication at a device, the apparatus comprising one or more memories and one or more processors coupled to the one or more memories, the one or more processors configured to cause the device to perform the method of one or more of Aspects 1-37.
Aspect 40: An apparatus for wireless communication, the apparatus comprising at least one means for performing the method of one or more of Aspects 1-37.
Aspect 41: A non-transitory computer-readable medium storing code for wireless communication, the code comprising instructions executable by one or more processors to perform the method of one or more of Aspects 1-37.
Aspect 42: A non-transitory computer-readable medium storing a set of instructions for wireless communication, the set of instructions comprising one or more instructions that, when executed by one or more processors of a device, cause the device to perform the method of one or more of Aspects 1-37.
Aspect 43: A device for wireless communication, the device comprising a processing system that includes one or more processors and one or more memories coupled with the one or more processors, the processing system configured to cause the device to perform the method of one or more of Aspects 1-37.
Aspect 44: An apparatus for wireless communication at a device, the apparatus comprising one or more memories and one or more processors coupled to the one or more memories, the one or more processors individually or collectively configured to cause the device to perform the method of one or more of Aspects 1-37.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive one or more parameters associated with computing perception data for an extended reality (XR) application; and
transmit computing information indicating whether an external device is to perform one or more tasks associated with computing the perception data,
wherein a determination of whether the external device is to perform the one or more tasks is based at least in part on the one or more parameters.

2. The UE of claim 1, wherein the computing information includes information identifying the external device based at least in part on the computing information indicating that the external device is to perform at least one of the one or more tasks.

3. The UE of claim 1, wherein the computing information includes information identifying a component of the UE based at least in part on the computing information indicating that the external device is not to perform at least one of the one or more tasks.

4. The UE of claim 1, wherein the one or more processors are further configured to cause the UE to:
determine, within an XR stack, whether the external device is to perform the one or more tasks associated with computing the perception data.

5. The UE of claim 1, wherein the one or more tasks associated with computing the perception data comprises a plurality of tasks.

6. The UE of claim 5, wherein the one or more processors are further configured to cause the UE to:
determine, for each task of the plurality of tasks, whether the external device is to perform the task.

7. The UE of claim 5, wherein the one or more processors are further configured to cause the UE to:
determine, for a task of the plurality of tasks, whether the external device is to perform a portion of the task.

8. The UE of claim 1, wherein the external device comprises a plurality of external devices.

9. The UE of claim 1, wherein the one or more parameters comprise one or more of privacy of a user associated with the perception data, a task that is a dependent task relative to the one or more tasks, a dependency relationship between the one or more tasks, a dependency relationship between the one or more tasks and another task associated with computing the perception data, one or more parameters associated with the external device, one or more parameters associated with a communication link established between the UE and the external device, or an application requirement associated with the XR application.

10. The UE of claim 1, wherein the one or more parameters are received via an application programming interface (API) associated with communicating data between a first component configured to determine whether the external device is to perform the one or more tasks and a second component configured to compute the perception data.

11. The UE of claim 10, wherein the computing information indicates that a task, of the one or more tasks, is to be performed by the external device and information indicating a communication link associated with communicating information with the external device, one or more parameters associated with the communication link, one or more parameters associated with an algorithm to be used by the external device to perform the task, or a combination thereof.

12. The UE of claim 10, wherein the one or more processors are further configured to cause the UE to:
receive, via the API, information indicating the one or more tasks.

13. The UE of claim 1, wherein the one or more tasks are associated with a depth map, a three-dimensional representation, a semantic segmentation, or a combination thereof.

14. The UE of claim 1, wherein the one or more parameters include a tasks dependency graph, a load of an input, a load of an output, a frame rate, an amount of power associated with performing the one or more tasks, a maximum round trip time associated with the external device performing the one or more tasks, a computation complexity associated with performing the one or more tasks, a privacy requirement associated with the one or more tasks, or a combination thereof.

15. The UE of claim 1, wherein the one or more parameters are received via an application programming interface (API) associated with communicating data between a first component configured to determine whether the external device is to perform the one or more tasks and the XR application.

16. The UE of claim 15, wherein the one or more processors are further configured to cause the UE to:
transmit, to the XR application and via the API, an indication of a type of perception algorithm available on the external device.

17. The UE of claim 15, wherein the one or more processors are further configured to cause the UE to:
receive, from the XR application and via the API, an indication of the one or more tasks, a type of perception algorithm associated with performing the one or more tasks, a quality metric associated with the one or more tasks, a preferred external device for performing the one or more tasks, or a combination thereof.

18. The UE of claim 17, wherein the indication of the one or more tasks includes an indication of a depth map, a three-dimensional representation, a semantic segmentation, or a combination thereof.

19. A method of wireless communication performed by a user equipment (UE), comprising:
receiving one or more parameters associated with computing perception data for an extended reality (XR) application; and
transmitting computing information indicating whether an external device is to perform one or more tasks associated with computing the perception data, wherein a determination of whether the external device is to perform the one or more tasks is based at least in part on the one or more parameters.

20. A non-transitory computer-readable medium storing a set of instructions for wireless communication, the set of instructions comprising:
one or more instructions that, when executed by one or more processors of a user equipment (UE), cause the UE to:
receive one or more parameters associated with computing perception data for an extended reality (XR) application; and
transmit computing information indicating whether an external device is to perform one or more tasks associated with computing the perception data, wherein a determination of whether the external device is to perform the one or more tasks is based at least in part on the one or more parameters.
